(19) United States
(12) Patent Application Publication
(10) Pub. No.: US 2026/0038932 A1
(43) Pub. Date: Feb. 5, 2026

(54) CONTAINER FOR BATTERY MODULES AND ASSOCIATED ELECTRICAL POWER STORAGE SYSTEM

(71) Applicant: SAFT, LEVALLOIS PERRET (FR)

(72) Inventors: Quentin LIEVOUX, LE BOUSCAT (FR); Jennifer CRONIER, MERIGNAC (FR); Stephen AICOBERRY, Saint Loubes (FR); Matthieu BERTIN, VILLENAVE D’ORNON (FR); Arnaud COLLIGNAN, SAINTE EULALIE (FR); Clément THÉTIOT, CARIGNAN DE BORDEAUX (FR); Jim MCDOWALL, Wallingford, CT (US)

(73) Assignee: SAFT, LEVALLOIS PERRET (FR)

(21) Appl. No.: 18/998,264

(22) PCT Filed: Jul. 27, 2023
(86) PCT No.: PCT/EP2023/070821

§ 371 Date: Jan. 24, 2025

(30) Foreign Application Priority Data
Jul. 27, 2022 (FR) FR2207737

(51) Int. Cl. H01M 50/24; H01M 10/42; H01M 10/627; H01M 10/658; H01M 50/204; H01M 50/251; H01M 50/271; H01M 50/289; H01M 50/296; H01M 50/30

(52) U.S. Cl. CPC H01M 50/24; H01M 10/425; H01M 10/627; H01M 10/658; H01M 50/251; H01M 50/271; H01M 50/289; H01M 50/296; H01M 50/30; H01M 2010/4271; H01M 50/204; H01M 2200/20

(57) ABSTRACT

The container includes a structure for receiving the battery modules, comprising upper corner pieces mounted on the upper corners of peripheral walls of the structure, the structure also including a roof extending between the upper corners.

The roof includes a water evacuation region, comprising at least two inclined faces inclined between a lower edge and at least one upper point common to the two inclined faces, in order to allow a flow of water received on each of the inclined faces to flow toward their lower edge thereof.

The water evacuation region is located in or below a plane (P) defined by the upper surfaces of the upper corner pieces.

### CROSS REFERENCE TO RELATED APPLICATIONS

The present application is a U.S. National Phase Application under 35 U.S.C. § 371 of International Patent Application No. PCT/EP2023/070821 filed Jul. 27, 2023, which claims priority of French Patent Application No. 22 07737 filed Jul. 27, 2022. The entire contents of which are hereby incorporated by reference.

### BACKGROUND

The present invention relates to a container for battery modules including a structure for receiving the battery modules, the structure comprising a floor, peripheral walls extending vertically around the periphery of the floor and defining upper corners, upper corner pieces mounted on the upper corners and projecting above the upper edges of the peripheral walls, the upper corner pieces each presenting an upper surface, the structure further including a roof extending between the upper corners, the roof, the peripheral walls and the floor defining an interior battery module storage volume.

Such a container is intended to hold battery modules to offer a displaceable source of electrical power, able to be installed, either temporarily or permanently at a site requiring electrical power.

Conventionally, an electrical power storage system is known to be built by arranging, in a standard parallelepiped container, the battery modules and an electrical and thermal module management unit. This storage system is easy to displace, particularly by road, rail, sea or air.

The structure of the container receiving the battery modules generally includes a floor, peripheral walls projecting, relative to the floor, and a flat roof which closes the inner volume containing the battery modules.

As standard, the container is fitted at its upper and lower corners with corner pieces. The lower corner pieces project downward relative to the floor, and the upper corner pieces project upward relative to the roof. Thus, the container can be arranged under another container, the lower corner pieces of the other container bearing on the upper corner pieces of the container.

Such a container does not give complete satisfaction when placed outside. The roof of the container being flat, rainwater that falls on the roof is likely to stagnate above the container. This stagnation occurs particularly in the center of the container, especially in the zones furthest from the lateral edges of the roof.

In some cases, stagnant rainwater can cause premature wear and tear on the container, in particular by promoting oxidation, or even by creating holes that communicate with the inner volume containing the battery modules. This can be detrimental to the operation of the container, since the battery modules are sensitive to water. In addition, the aesthetic appearance of the container is impaired.

To alleviate this problem, CN212461856U is known, for example, to arrange a steep roof above the container that prevents rainwater from stagnating when it falls on the container.

Such a solution effectively protects the container. However, it is not satisfactory, as the container can only be transported on top of a stack of containers, without being able to receive additional containers on top of it. The steep roof increases transport costs and makes container handling more difficult.

To avoid problems during transport, the steep roof according to CN212461856U can therefore not be installed during the assembly of the storage system and must only be installed once the container is on site.

### SUMMARY

One aim of the invention is therefore to obtain a container for battery modules that is highly weather-resistant, yet simple and inexpensive to transport.

To this end, the subject matter of the invention is a container of the aforementioned type, characterized in that the roof includes at least one water evacuation region, the water evacuation region comprising at least two inclined faces between a lower edge and at least one upper point common to the two inclined faces, to allow a flow of water received on each of the inclined faces toward their lower edge, the water evacuation region being located in or below a plane defined by the upper surfaces of the upper corner pieces.

The container according to the invention may comprise one or more of the following features, taken in isolation or in any technically possible combinations:
the peripheral walls include two opposite longitudinal walls, extending along a longitudinal axis of the container, and two transverse walls, extending perpendicularly to the longitudinal axis, at least two inclined faces being longitudinal inclined faces inclining away from each other toward the opposite longitudinal walls;
the roof includes at least four inclined faces, at least two inclined faces being transverse inclined faces inclining away from each other toward the transverse walls;
the four inclined faces are pyramid-shaped, the upper point being common to all the inclined faces and forming the apex of the pyramid;
two inclined faces have a common upper edge, the common upper edge defining a plurality of common upper points;
the structure includes at least one structural bearing surface extending between two peripheral walls below the two inclined faces, the structure further including at least one reinforcing strut interposed between the structural bearing surface and at least one of the inclined faces;
the structure includes a roof supporting framework including at least one longitudinal member extending along a longitudinal axis of the container, and/or at least one transverse member extending transversely relative to the longitudinal axis of the container, the structural bearing surface extending over the longitudinal member and/or the transverse member;
the roof further includes at least one non-inclined region adjacent to the water evacuation region;
the roof includes two non-inclined regions located on either side of the water evacuation region;
the roof is devoid of any non-inclined region;
a non-inclined region of the roof and/or at least one inclined face defines at least one through opening for evacuating excess pressure in the inner volume, the roof including a deflagration panel attached on the through opening, the deflagration panel being able to at least partially release the through opening in the event of excess pressure above a given threshold in the inner volume;
the peripheral walls delimit the lower corners, the structure including lower corner pieces mounted beneath the lower corners and being located in register with the upper corner pieces;
the structure includes a layer of thermal insulation arranged at least under the inclined faces.

The subject matter of the invention is also an electrical power storage system, including:
a container such as defined above;
battery modules received in the inner volume;
terminals, connected to the battery modules and intended to be connected to a consumer of electrical power supplied by the battery modules and/or to an electrical power supplier for recharging the battery modules.

The system according to the invention may comprise the following features:
the structure includes an internal partition separating the inner volume to delimit a control room receiving at least one battery module management system, and at least one storage room receiving the battery modules.

### BRIEF DESCRIPTION OF THE DRAWINGS

The invention will be better understood on reading the following description, given by way of example only, and made with reference to the appended drawings, on which:

FIG. 1 is a perspective view of a first displaceable electrical energy storage system comprising a container of battery modules according to the invention, the container being partially open;

FIG. 2 is a top perspective view of the roof of the container of FIG. 1;

FIG. 3 is a schematic view representing one example of the roof support structure of the container of FIG. 1;

FIG. 4 is a schematic view illustrating the reinforcing struts of the inclined faces of FIG. 1, allowing an operator to walk on the container;

FIG. 5 is a view similar to FIG. 3 of a container roof of a second electrical energy storage system according to the invention; and

FIG. 6 is a view similar to FIG. 2 of a container roof of a third electrical energy storage system according to the invention.

### DETAILED DESCRIPTION

Hereafter, orientations are generally defined relative to the position of a container resting on a horizontal flat surface. In particular, the terms “under”, “below”, “on”, “above” are generally understood in relation to this container position.

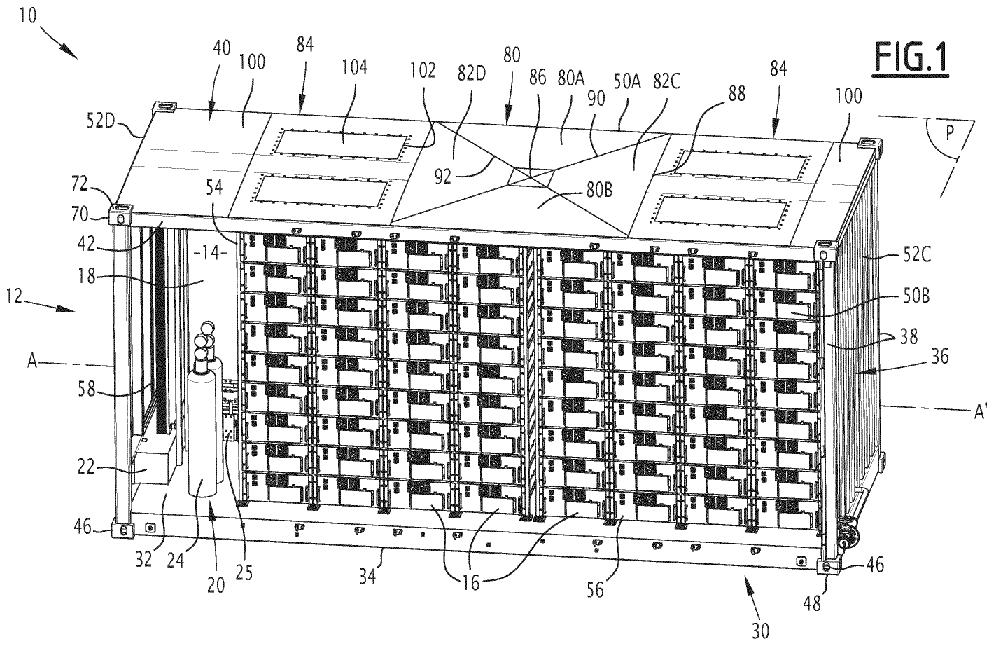

A first electrical energy storage system 10 according to the invention is illustrated in FIG. 1.

The storage system 10 is intended to be moved to a site of use, for example, by a road vehicle such as a truck, by a rail vehicle, or/and by a sea vehicle such as a transport vessel. It is intended to be electrically connected to an electrical energy utilization network at a site of use and alternately to an electrical energy supply network for recharging.

As illustrated in FIG. 1, the storage system 10 includes a container 12 of battery modules, delimiting an inner volume 14, and a plurality of battery modules 16 received in the inner volume 14. Advantageously, the storage system 10 includes a Battery Management Module (BMM) system 18 for electrical and thermal management of the battery modules 16, and a safety system 20.

In this example, the container 12 contains, for example, between 10 and 150 battery modules 16. The battery modules 16 are arranged in columns and rows. They are connected in series and/or parallel to deliver, to at least two electrical terminals 22 present on the container 12, electrical power of up to 4 MWh at voltages of up to 1500V.

Each battery module 16 includes a plurality of electrochemical cells, for example, received in prismatic or cylindrical cases or in flexible pouches. Each electrochemical cell includes anodes, cathodes and separators, between which electrochemical reactions take place.

The management system 18 is able to control the voltage and current delivered by each battery module 16 while electrical power is supplied, and the electrical power and current delivered to each battery module 16 when recharging the battery modules 16.

The electrical terminals 22 are intended to be connected to the user network (not represented) for the supply of electrical energy stored in the battery modules 16, and alternately, to an electrical power supply network, for recharging the battery modules 16.

The safety system 20 includes, for example, sensors (not represented) for detecting temperature and/or pressure in the inner volume 14, a source of inert gas 24, and a control unit 25, able to deliver the inert gas into the inner volume 14 from the source of inert gas 24, upon detection of an increase in temperature and/or pressure above a given threshold in the inner volume 14.

In the example represented in FIG. 1, the container 12 comprises a self-supporting structure 30, intended to define the inner volume 14, and to allow the battery modules 16, the module management system 18, and the safety system 20 to be transported together to a site of use.

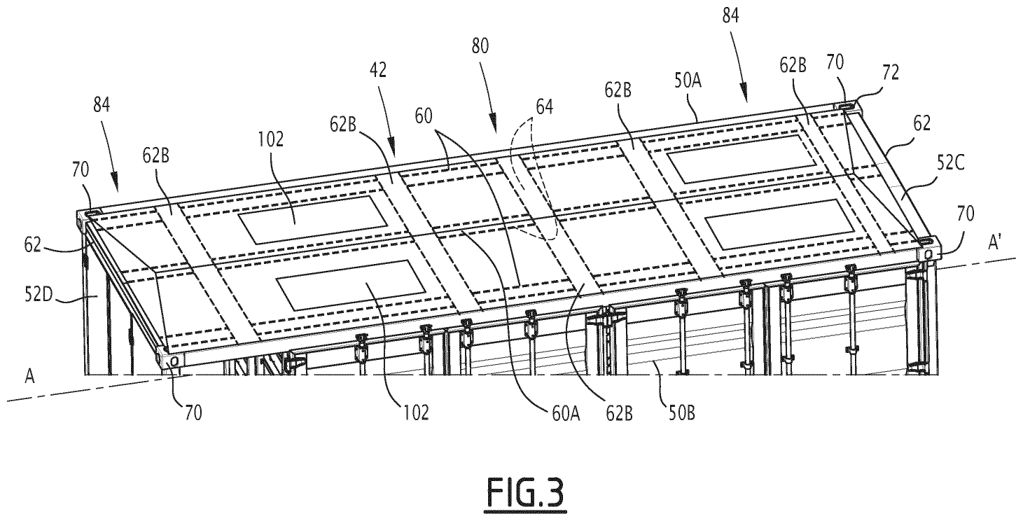

The structure 30 includes a floor 32 mounted on a floor support 34. It includes peripheral walls 36 projecting from the periphery of the floor 32, the peripheral walls 36 being supported by vertical pillars 38 at the corners of the walls 36. It also includes a roof 40 carried by a supporting framework 42, visible in particular in FIG. 3.

The structure 30 of the container 12 is polyhedral in shape here. In particular, the structure 30 presents the shape of a rectangular parallelepiped, extending longitudinally along a longitudinal axis A-A′ which is horizontal when the container 12 is placed on a horizontal support.

The container 12 has, for example, a length greater than 2 m, in particular between 2.5 m and 15 m, a width greater than 1 m, in particular between 2 m and 4 m, and a height greater than 1 m, in particular between 2 m and 4 m.

In particular, the container 12 is a 20 ft “High Cube” container measuring 6.058 m in length, 2.438 m in width and 2.896 m in height. However, the present invention applies to any type of container with ISO corners (for example, 40 ft (12 m), 10 ft (3 m), etc.).

The floor 32 here is flat. It supports the battery modules 16, the management system 18 as well as the safety system 20 when it is present. The floor 32 delimits the inner volume 14 toward the bottom.

The floor support 34 includes, for example, beams, particularly of the IPN type, extending longitudinally along the edges of the structure 30, and at the longitudinal ends of the structure 30, the transverse crossmembers connect the longitudinal beams.

The floor 32 is mounted in abutment on the floor support 34. The floor support 34 is, for example, able to be gripped by the gripping members of a crane, in order to lift the container 12 and displace it.

The floor support 34 is equipped with lower corner pieces 46 extending at each corner defined between two adjacent peripheral walls 36.

The lower corner pieces 46 present a lower surface 48 intended to rest on the ground or other support, the floor 32 then being located above the ground or support.

In this example, each lower corner piece 46 is located beneath a vertical pillar 38.

The peripheral walls 36 include two vertical longitudinal walls 50A, 50B (the wall 50B has been removed from FIG. 1, but is visible in particular in FIG. 3), the longitudinal walls 50A, 50B being arranged vertically, parallel to the axis A-A′, on either side of the axis A-A′.

The peripheral walls 36 further include two vertical transverse walls 52C, 52D extending perpendicularly to the axis A-A′ and connecting the longitudinal walls 50A, 50B to each other at the longitudinal ends of the structure 30.

The longitudinal walls 50A, 50B and possibly the transverse walls 52C, 52D delimit pairwise the corners of the structure 30. They delimit the inner volume 14 toward the outside.

The longitudinal walls 50A, 50B and possibly the transverse walls 52C, 52D are equipped with movable doors, allowing for example, to offer an access passage to the inner volume 14 from the outside of the container 12.

Advantageously, the structure 30 also includes an internal partition 54 to the inner volume 14, delimiting in the inner volume 14 a room 56 for storing the battery modules 16, and separately, a control room 58, receiving the management system 18 and the safety system 20.

Advantageously, at least one door arranged in a peripheral wall 36 allows access to the storage room 56, without having to open the control room 58, and at least one other door allows access to the control room 58, without having to open the storage room 56.

With reference to FIG. 3, the support frame 42 includes a plurality of longitudinal members 60, and advantageously a plurality of crossmembers 62 connecting the longitudinal members 60 transversely to each other.

At least two lateral longitudinal members 60 connect the pillars 38 parallel to the axis A-A′. At least two end crossmembers 62 connect the pillars 38 transversely to the axis A-A′.

In this example, the support frame 42 further includes at least one additional longitudinal member 60A arranged between the lateral longitudinal members 60, and a plurality of additional crossmembers 62B arranged between the end crossmembers 62. The longitudinal members 60, 60A and crossmembers 62, 62B define, beneath the roof 40, at least one bearing surface 64 supporting the roof 40.

The longitudinal members 60 and the crossmembers 62 are dimensioned to support the roof 40 and at least one equipped human being walking on the roof, the equipped human being weighing, for example, 100 kg.

The support frame 42 also includes upper corner pieces 70 intended to project above the vertical pillars 38, above the roof 40. The corner pieces 70 define an upper surface 72 that is flat and horizontal when the axis A-A′ is horizontal.

As visible in FIGS. 1 and 3, the upper surfaces 72 of the corner pieces 70 define an upper plane P of the container 12, with no element of the container 12 projecting beyond the upper plane P.

The roof 40 is preferably made of metal, in particular steel, and is advantageously covered with a protective coating, in particular anti-rust paint.

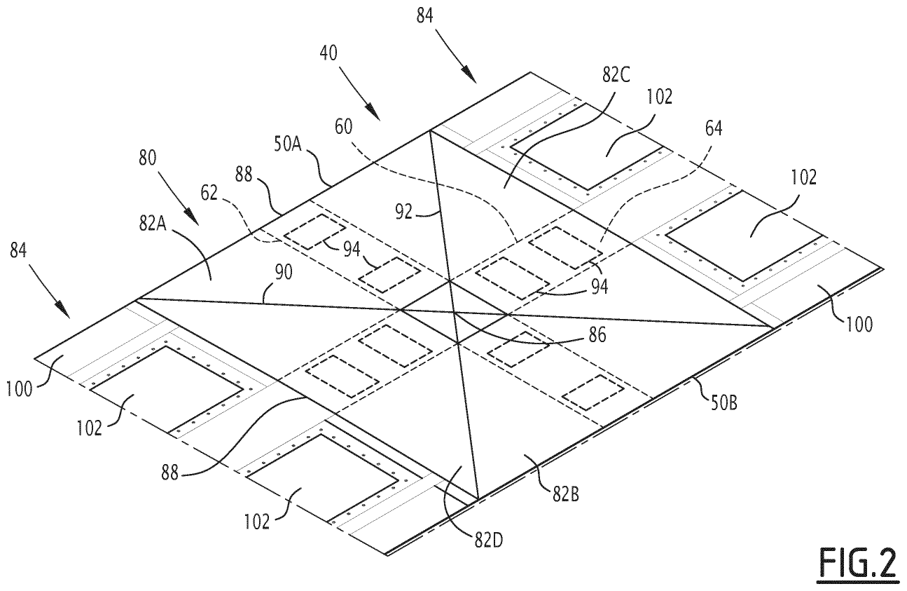

According to the invention, in the example of FIG. 2, the roof 40 of the structure 30 includes a central water evacuation region 80, equipped with at least two inclined faces 82A to 82D and advantageously, two non-inclined regions 84, located longitudinally on either side of the central region 80.

The central region 80 extends over a length of at least 10%, preferably at least 20%, of the length of the roof 40, taken along the axis A-A′.

In the example represented in FIG. 1, the central region 80 includes four inclined faces 82A to 82D defining a pyramid.

With reference to FIG. 2, the central region 80 thus comprises two longitudinal inclined faces 82A, 82B, with inclinations directed laterally, respectively toward the longitudinal walls 50A, 50B, and two transverse inclined faces 82C, 82D with inclinations directed longitudinally, respectively toward the transverse walls 52C, 52D.

Each inclined face 82A to 82D presents a substantially triangular shape defining an upper point 86 common to all four inclined faces 82A to 82D.

Each inclined face 82A to 82D includes a lower edge 88 and two edges 90, 92 converging from the ends of the lower edge 88 toward the upper point 86.

The lower edges 88 of the inclined longitudinal faces 82A, 82B extend along the respective longitudinal walls 50A, 50B, above these walls, in particular on the upper surface defined by the longitudinal members 60.

The lower edges 88 of the transverse inclined faces 82C, 82D extend parallel to the transverse walls 52C, 52D, preferably facing a crossmember 62. They delimit, toward the center of the roof 40, the non-inclined regions 84.

The central water evacuation region 80 is entirely located in and under the upper plane P defined by the upper surfaces 72 of the upper corner pieces 70 or entirely under the upper plane P. It does not project above the upper plane P.

Thus, the upper point 86 is located in the plane P, or below the plane P when the container 12 rests horizontally on a horizontal support.

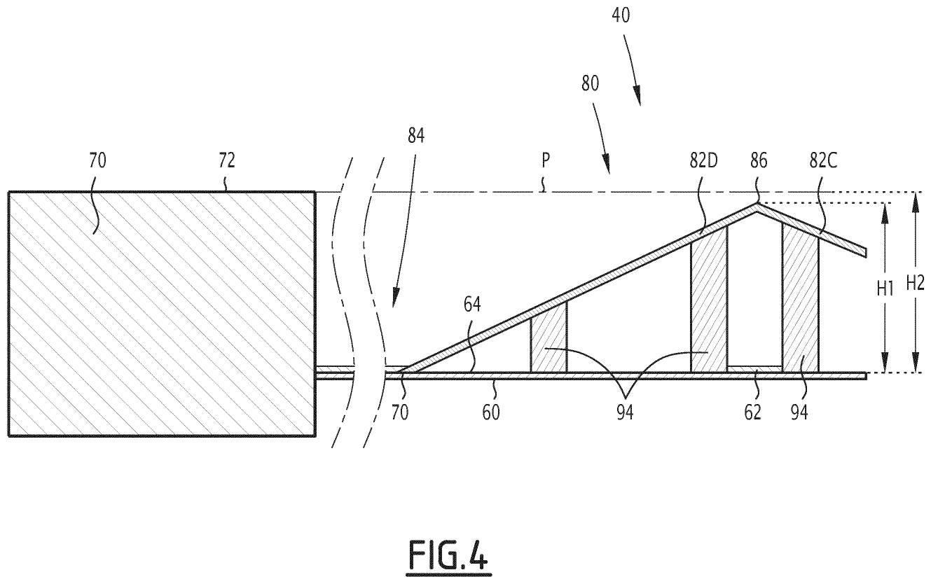

With reference to FIG. 4, the height H1 of the upper point 86, taken vertically from the bearing surface 64 defined on the longitudinal members 60, is less than or equal to the height H2 of the upper surfaces 72 of the upper corner pieces 70, taken vertically from the bearing surface 64.

The height H2 is between 20 mm and 30 mm. The height H1 guarantees that a distance of at least 5 mm is maintained below the plane P.

Thus, the central water evacuation region 80 does not interfere with an additional container which would be placed by its lower corner pieces on the upper corner pieces 70 of the container 12.

The angle of inclination of each inclined face 82A to 82D relative to a horizontal plane is, for example, less than 10°, and in particular between 1° and 5° for the usual dimensions of a container 12.

The area occupied by the inclined faces 82A to 82D of the central water evacuation region 80 is thus advantageously greater than at least 3% of the total area of the roof 40, the areas being taken in projection in a horizontal plane.

Advantageously, to reinforce the rigidity of the central region 80, and in particular, the rigidity of each inclined face 82A to 82D, the roof 40 includes reinforcing struts 94, extending between the bearing surface 64 and a lower surface of the inclined face 82A to 82D.

In the example represented in FIG. 2, the roof 40 comprises at least one reinforcing strut 94 located between the bearing surface 64 and each inclined face 82A to 82D, preferably at least two spaced-apart reinforcing struts 94 interposed between the bearing surface 64 and each inclined face 82A to 82D.

For the inclined longitudinal faces 82A, 82B, the reinforcing struts 94 are arranged on a bearing surface 64 defined by a crossmember 62. For the inclined transverse faces 82C, 82D, the reinforcing struts 94 are arranged on the bearing surface 64 defined by a longitudinal member 60, in particular by a central longitudinal member parallel to the axis A-A′.

Thanks to the presence of the reinforcing struts 94 located under the inclined faces 82A, 82B, the central water evacuation region 80 is able to carry an operator equipped with his equipment (for example weighing 100 kg with his equipment), without deforming the inclined faces 82A, 82B. In addition, the shape and inclination of the transverse inclined faces 82C, 82D reinforce the structural rigidity of the water evacuation region 80, allowing the operator to walk on the roof 40, without buckling of the inclined faces 82A to 82D.

With particular reference to FIG. 1, each non-inclined region 84 includes at least one horizontal roof panel 100 extending longitudinally between the upper edge of a respective transverse wall 50C, 50D and the central water evacuation region 80 and extending transversely between the upper edges of the longitudinal walls 50A, 50B.

Each non-inclined region 84 defines at least one through opening 102 for evacuating the excess pressure in the inner volume 14, and for each through opening 102, a deflagration plate 104 attached to the roof panel 100 around the perimeter of the through opening 102, for closing in a sealed manner the through opening 102, in the absence of excess pressure above a calibrated threshold in the inner volume 14.

The roof panel 100 is supported by the bearing surfaces 64 defined on the longitudinal members 60 and the crossmembers 62.

In this example, each through opening 102 passes vertically through the roof panel 100. The roof panel 100 includes two parallel through openings 102 located on either side of the axis A-A′, projected in a horizontal plane.

Each through opening 102 here presents a contour, for example polygonal, in particular, a rectangular contour.

The deflagration plates 104 are attached to the periphery of the through openings 102. The fixing is configured to define the calibrated excess pressure threshold beyond which the deflagration plate 104 opens to partially release the through opening 102 and reduce the pressure inside the inner volume 14.

Each roof panel 100, and each deflagration plate 104 attached to the roof panel 100, is located below the upper plane P defined by the upper surfaces 72 of the upper corner pieces 70. In addition, the deflagration plates 104 present an upper surface located vertically below the upper point 86 of the inclined faces 82A to 82D.

Thanks to the presence of the central water evacuation region 80, rainwater falling at the level of the central water evacuation region 80 is evacuated naturally toward the lateral edges of the container 12 due to the inclined faces 82A, 82B, and away from the center of the roof 40 by the inclined faces 82C, 82D.

Thus, the accumulation of water in the center of the roof 40 is eliminated, or at least very significantly reduced. This limits the risk of water stagnation, and therefore of damage to the roof 40 of the container 12 at its center. The formation of holes by corrosion impairing the watertightness of the container 12 is thus avoided.

The container 12 therefore presents a longer service life, a greater reliability for the battery modules 16 it contains, since these are not exposed to moisture. In addition, it has an improved external aesthetic appearance, even when subjected to adverse weather conditions.

The central water evacuation region 80, being located below the plane P defined by the top surfaces 72 of the top corner pieces 70, does not interfere with the normal transport of the container 12. In particular, the container 12 can be transported under other containers in a stack of containers, by receiving, on its upper corner pieces 70, lower corner pieces of another container. In particular, this allows it to be loaded onto ships, thus reducing transport costs.

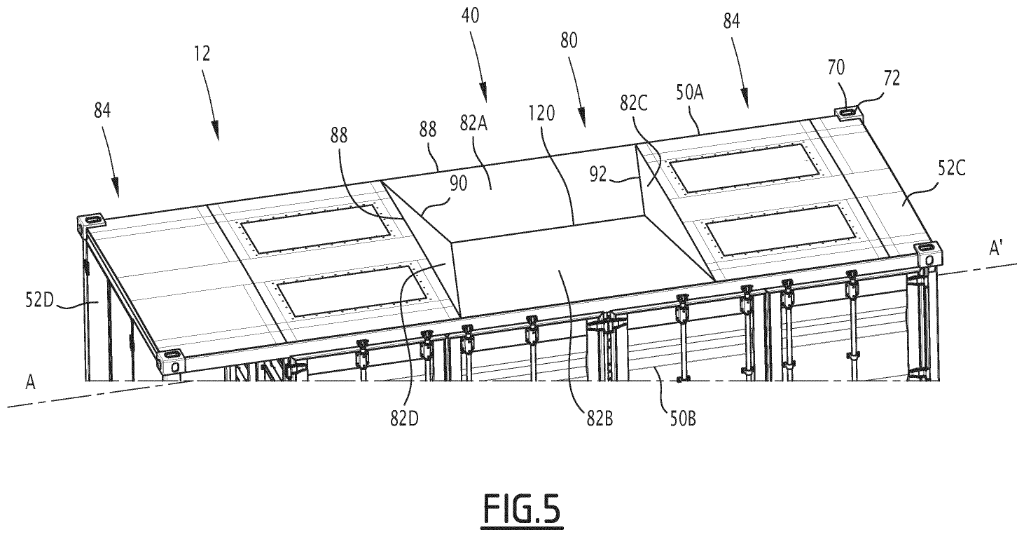

In one alternative, visible in FIG. 5, the longitudinal inclined faces 82A, 82B present, projected in a horizontal plane, an area greater than that of the transverse inclined faces 82C, 82D. In particular, the area of the longitudinal inclined faces 82A, 82B is greater than 200% of the area of the transverse inclined faces 82C, 82D.

The longitudinal faces 82A and 82B delimit between them a horizontal upper edge 120, extending parallel to the axis A-A′ and defining a plurality of upper points 86 of the central water evacuation region 80. The upper edge 120 extends between the edges 88, 90 of each face 82A, 82B.

As before, the top edge 120 thus defined is located in the plane P, or below the plane P defined by the upper surfaces 72 of the upper corner pieces 70.

The longitudinal inclined faces 82A, 82B thus present a trapezoidal contour, while the transverse longitudinal faces present a triangular contour.

Such an arrangement optimizes flow toward the longitudinal walls 50A, 50B, and not toward the non-inclined regions 84. Water stagnation is therefore even more limited.

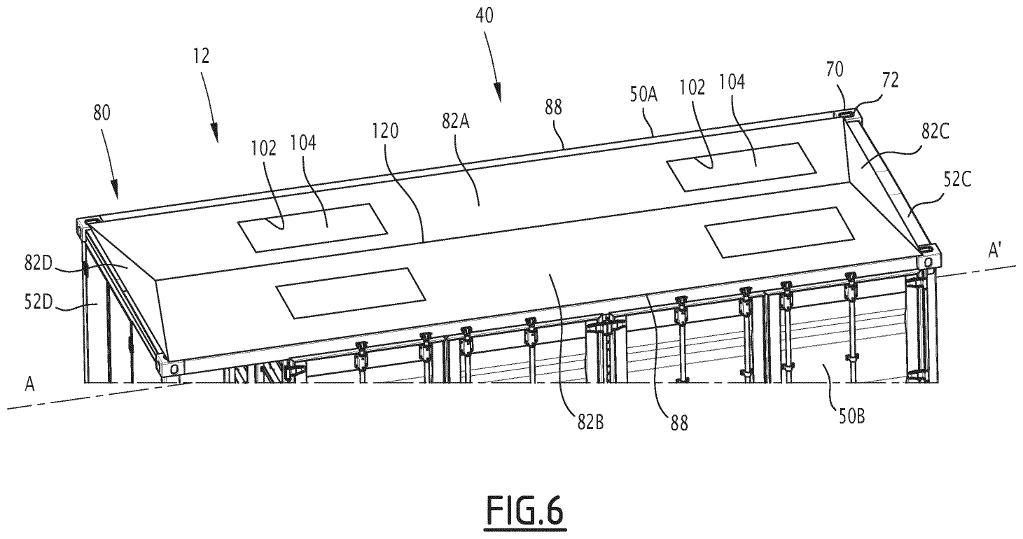

In the alternative illustrated in FIG. 6, the roof 40 is devoid of a non-inclined region 84.

The water evacuation area 80 extends over the entire length and width of the roof 40.

In this example, projected in a horizontal plane, the area occupied by the inclined transverse faces 82C, 82D is preferably less than 10% of the area occupied by the inclined longitudinal faces 82A, 82B.

As before, the entire water evacuation region 80, including the upper edge 120, is located in the plane P or below the plane P.

In this alternative, the through openings 102 for pressure evacuation are arranged directly in the inclined faces 82A, 82B and the deflagration plates 104 are attached to the inclined faces 82A, 82B around the periphery of the through openings 102, as described above.

In one alternative, a layer of thermal insulation, for example a fibrous layer realized of rock wool, is arranged under the roof 40, in particular in the volume delimited between the bearing surface 64 and the inclined faces 82A to 82D. This alternative promotes thermal insulation of the battery modules 16, particularly when the temperature increases outside the energy storage system 10.

1. A battery module container including a structure configured to receive battery modules, the structure comprising a floor, peripheral walls extending vertically around the periphery of the floor and defining upper corners, upper corner pieces mounted on the upper corners and projecting above upper edges of the peripheral walls, the upper corner pieces each presenting an upper surface, the structure further comprising a roof extending between the upper corners, the roof, the peripheral walls, and the floor delimiting an inner volume configured to store the battery modules,
the roof comprising at least one water evacuation region, the at least one water evacuation region comprising at least two inclined faces, inclined between a lower edge and at least one upper common to the at least two inclined faces, to allow a flow of water received on each of the at least two inclined faces toward their lower edges, the at least one water evacuation region being located in or below a plane defined by the upper surfaces of the upper corner pieces.

2. The container according to claim 1, wherein the peripheral walls include two opposing longitudinal walls extending along a longitudinal axis of the container, and two transverse walls, extending perpendicularly to the longitudinal axis, the at least two inclined faces being comprising at least two longitudinal inclined faces inclined opposite from each other toward the opposite longitudinal walls.

3. The container according to claim 2, wherein the at least two inclined faces—includes at least four inclined faces, including at least two transverse inclined faces inclining opposite from each other toward the transverse walls.

4. The container according to claim 3, wherein the at least four inclined faces form a pyramid shape, the at least one upper point being common to all the at least four inclined faces and forming an apex of the pyramid shape.

5. The container according to claim 1, wherein the at least two inclined faces have a common top edge, the common top edge defining a plurality of common top points.

6. The container according to claim 1, wherein the structure includes at least one structural bearing surface extending between two peripheral walls below the at least two inclined faces, the structure further including at least one reinforcing strut interposed between the structural bearing surface and at least one of the at least two inclined faces.

7. The container according to claim 6, wherein the structure includes a framework supporting the roof, the framework including at least one stringer extending along a longitudinal axis of the container, and/or at least one crossmember, extending transversely relative to the longitudinal axis of the container, the structural bearing surface extending over the stringer—and/or over the crossmember.

8. The container according to claim 1, wherein the roof further includes at least one non-inclined region adjacent to the at least one water evacuation region.

9. The container according to claim 8, wherein the roof includes two non-inclined regions located on either side of the at least one water evacuation region.

10. The container according to claim 1, wherein the roof is devoid of a non-inclined region.

11. The container according to claim 1, wherein a non-inclined region of the roof or/and the at least one inclined face defines at least one through opening configured to evacuate excess pressure in the inner volume, the roof including a deflagration panel attached to block the through opening, the deflagration panel being configured to at least partially release the through opening in the event of excess pressure above a given threshold in the inner volume.

12. The container according to claim 1, wherein the peripheral walls delimit lower corners, the structure including lower corner pieces mounted under the lower corners and being located in register with the upper corner pieces.

13. The container according to claim 1, wherein the structure includes a layer of thermal insulation arranged at least under the at least one inclined face.

14. An electrical power storage system, including:
a container according to claim 1;
battery modules received in the inner volume;
terminals, connected to the battery modules and configured to connect to a consumer of electrical power supplied by the battery modules and/or to an electrical power supplier configured to recharge the battery modules.

15. The storage system according to claim 14, wherein the structure includes an internal partition separating the inner volume to delimit a control room receiving at least one management system configured to control the battery modules, and at least one storage room receiving the battery modules.
